(19) United States
(12) Patent Application Publication
(10) Pub. No.: US 2011/0132948 A1
(43) Pub. Date: Jun. 9, 2011

(54) TRUNK WITH DRINK HOLDER FOR MOTORCYCLES

(76) Inventor: James R. CARPENTER, Shawnee, KS (US)

(21) Appl. No.: 12/960,881

(22) Filed: Dec. 6, 2010

Related U.S. Application Data
(60) Provisional application No. 61/267,678, filed on Dec. 8, 2009.

(51) Int. Cl. B62J 9/00

(52) U.S. Cl. 224/413

(57) ABSTRACT

Devices and methods are disclosed which relate to drink holders mounted on a trunk for a motorcycle. A mounting bracket is attached to a trunk towards the rear of the motorcycle. The mounting bracket contains a flange at a first end where fasteners attach the mounting bracket to the trunk. The mounting bracket fixedly attaches to the drink holder at a second end of the mounting bracket. An attachment member of a drink holder is secured to the mounting bracket where the drink holder is held fixedly in place.

### CLAIM FOR PRIORITY

This application claims the benefit of provisional application 61/267,678, filed on Dec. 8, 2009, which is hereby incorporated by reference in its entirety.

### BACKGROUND OF THE INVENTION

1. Field of the Invention

The present invention relates to drink holders for motorcycles. More specifically, the present invention relates to drink holders for trunks on motorcycles.

2. Background of the Invention

Today there are many motorcycles on the road. Since the invention of the motorcycle in 1885 many have found motorcycles a means of transportation, sport, show, and other endeavors. From small and lightweight motorcycles used in sports for speed and stunts to large and powerful motorcycles used for traveling distances, motorcycles come in many different forms and encompass activities shared across the world.

Many use motorcycles for everyday transportation. In the summertime the motorcycle can be seen as the ultimate convertible. Having little exterior paneling the breeze is allowed to flow across virtually the entire body. When compared to an automobile, the relatively compact size of a motorcycle allows for easier parking in metropolitan areas. Motorcycles are much more agile than automobiles as well, due to their lighter weight and in-line wheel design. In California, motorcyclists are allowed to travel in between the lanes of traffic, which comes in handy during rush hour when the rest of traffic comes to a stop. The idea of not having to slow down when traffic gets bad makes motorcycles an extremely attractive alternative to an automobile.

As the price in petroleum keeps rising many find themselves searching for more fuel efficient means of transportation. While automobile manufacturers design engines that run on ethanol, biodiesel fuel, electricity, and even hybrids, motorcycles, by their lightweight nature, are much more fuel efficient than any automobile. It is common for motorcycles to range between forty and sixty miles-per-gallon, and it has been that way for years now. Some motorcycles are specifically tuned to enjoy an even higher gas-mileage rating.

Others use motorcycles for sport. Sport motorcycles are nearly all fast and lightweight. Some are equipped with fat tires with large tread for traction in the mud. Large dirt courses are constructed where motorcyclists race across hills and around sharp turns. Courses are constructed in a similar manner but used solely for stunt competitions. As most of these stunts are aerial the courses consist of large ramps resulting in the long hang time necessary for a well-executed stunt. A few motorcyclists make a living doing nothing but stunts. These motorcyclists do not even compete with other motorcyclists, but simply attempt elaborate and seemingly impossible feats in order to draw large crowds which cheer wildly upon completion of the stunt. Of course there are also track motorcycle races which are closer related to an automobile racing event than dirt bike races. Though a lighter weight vehicle is desirable, these motorcycles do not sacrifice power and acceleration for a lighter weight. Few tricks and stunts are employed as these races are about skill, concentration, and determination.

Then there are those motorcycle enthusiasts that enjoy traveling long distances on their motorcycles. They typically employ larger motorcycles tuned for a smoother ride. These motorcycles come with larger fuel tanks so that the rider doesn't need to stop for fuel as often. Large bins may be attached to either side of the seat on these motorcycles, known as saddlebags. Saddlebags come in handy for the distance motorcyclist to hold belongings, food, etc. They can be made from leather or vinyl. Some saddlebags are made from fiberglass or polyvinylchloride (PVC) and are constructed by the manufacturer as part of the body of the motorcycle. A glove box can be found near the front for smaller personal items. Advances in sound systems for motorcycles have led to front and rear speakers. Trunks are added toward the rear of the motorcycle to hold the rear speakers. A few motorcycles exist with another passenger hold known as a side car which looks a little like a small chariot attached to the rear side of a motorcycle. The addition of a side car makes the motorcycle a three-wheeled vehicle, with the third wheel holding up the far side of the side car. A side car motorcycle may be a little less agile, but can make a more comfortable ride for a passenger traveling long distances.

Motorcycle enthusiasts also enjoy assembling at large events for motorcyclists. These events can be found across the United States and many other countries. Massive conventions are held where motorcyclists meet to display the latest technology, sell their latest products, exchange ideas and techniques, and, of course, to show off their own motorcycles. Some of the most aesthetically pleasing motorcycles appear at these events. Many of the enthusiasts present at these events must travel long distances before arriving. Some have large trucks pulling covered trailers which store their motorcycles, but many don't have that luxury and ride the whole distance. Many of these enthusiasts are the same that enjoy traveling long distances on their motorcycles, but also have an interest in keeping their motorcycle aesthetically pleasing.

Aesthetics and convenience often clash. Motorcycles, even long distance cruisers, are small when compared to any other long distance vehicle, and have little room for cargo holds. The saddle bags and glove boxes are still no comparison to the size of a trunk of an automobile, but are carefully constructed to as not to detract from the overall appearance of the motorcycle. Still there is little innovation when it comes to holding a drink while riding a motorcycle. Studies have shown that a drink holder or amount thereof can rank very high among consumers when purchasing an automobile, yet there are very options for a motorcyclist.

A few aftermarket drink holders are made which clamp onto the handlebars of a motorcycle. This would seem like an ideal placement, but it has its drawbacks. The drink holder can get in the way of a motorcyclists vision and movements. Access to switches can become awkward and important gauges can be hidden. A motorcyclist's view of the road is encroached and all of these problems increase when the drink holder is actually holding a drink. The handlebars and front wheel, which govern the direction of the motorcycle, experience more motion due to turning back and forth than the rest of the body of the motorcycle. Having a drink mounted to the handlebars increases the risk of spills. Furthermore, a passenger has even fewer options when it comes to a drink holder.

When it comes to aesthetics, a drink holder is not the most flattering accessory to have on your motorcycle. Many drink holders are large plastic canisters which can seem a little out of place when perched upon a shining flow of steel, custom paint, and leather.

What is needed in the art is a drink holder for a motorcycle that does not inhibit the rider's vision or access to controls. A drink holder for a motorcycle needs to be in a position where it is not prone to spills. Finally, a drink holder for a motorcycle should not take away from the aesthetic appeal of the motorcycle.

### SUMMARY OF THE INVENTION

The present invention is a drink holder mounted on a trunk for a motorcycle. Exemplary embodiments of the present invention include a mounting bracket attached to a trunk of the motorcycle. The mounting bracket contains a flange at a first end where fasteners attach the mounting bracket to the trunk. The mounting bracket fixedly attaches to the drink holder at a second end of the mounting bracket. An opening for receiving a drink holder is included in the mounting bracket. An attachment member of a drink holder is secured to the mounting bracket where the drink holder is held fixedly in place.

### BRIEF DESCRIPTION OF THE DRAWINGS

FIGS. 1A-C show a mounting bracket for attaching a drink holder to a trunk of a motorcycle, according to an exemplary embodiment of the present invention.

FIGS. 2A-B show a mounting bracket for a drink holder attached to a trunk of a motorcycle, according to an exemplary embodiment of the present invention.

FIGS. 3A-B show a drink holder attached to a trunk of a motorcycle, according to an exemplary embodiment of the present invention.

FIGS. 4A-B show a mounting bracket for attaching a drink holder to a trunk of a motorcycle according to an exemplary embodiment of the present invention.

FIGS. 5A-B show a mounting insert for attaching a drink holder to a trunk of a motorcycle, according to an exemplary embodiment of the present invention.

FIGS. 6A-B show a mounting adjuster for attaching a drink holder to a trunk of a motorcycle, according to an exemplary embodiment of the present invention.

FIGS. 7A-B show a securing member for attaching a drink holder to a trunk of a motorcycle, according to an exemplary embodiment of the present invention.

FIG. 8 shows an assembly for attaching a drink holder to a trunk of a motorcycle, according to an exemplary embodiment of the present invention.

### DETAILED DESCRIPTION OF THE INVENTION

The present invention is a drink holder mounted on a trunk for a motorcycle. Exemplary embodiments of the present invention include a mounting bracket attached to a trunk towards the rear of the motorcycle. The mounting bracket contains a flange at a first end where fasteners attach the mounting bracket to the trunk. The mounting bracket fixedly attaches to the drink holder at a second end of the mounting bracket. An opening for receiving a drink holder is included in the mounting bracket. An attachment member of a drink holder is secured to the mounting bracket where the drink holder is held fixedly in place.

“Drink”, as used in this disclosure, refers to a liquid beverage and its container. Most any substantially cylindrical container fits within the scope of this disclosure. Examples of a drink include a can of soda, a bottle of water, a sports drink in a plastic bottle, a mug of coffee, a squirt bottle having liquid, a paper cup having liquid, etc.

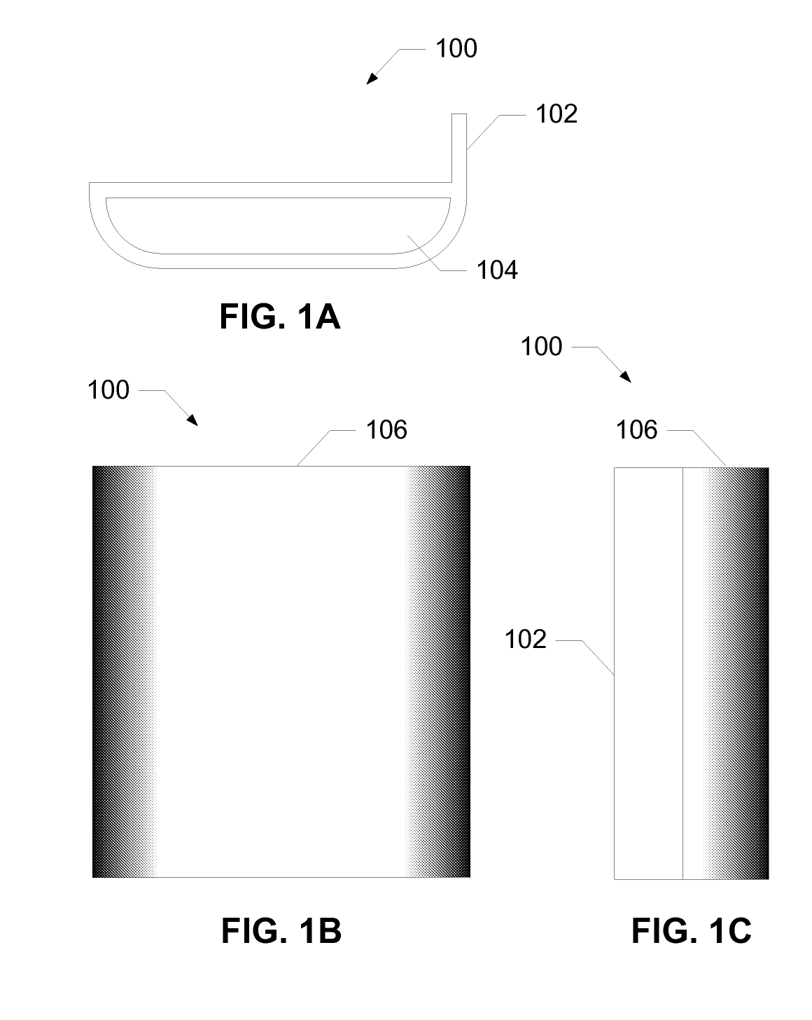

FIGS. 1A-C show a mounting bracket 100 for attaching a drink holder to a trunk of a motorcycle, according to an exemplary embodiment of the present invention. FIG. 1A shows a first view of mounting bracket 100 including a flange 102, and cavity 104. Flange 102 attaches to the trunk using screws or other fasteners. Cavity 104 is an open chamber for receiving a mounting insert. Cavity 104 is sized so that the mounting insert slides in and is substantially fixed. FIG. 1B shows a second view of mounting bracket 100. An opening 106 leads to cavity 104. FIG. 1C shows a third view of mounting bracket 100. Flange 102 can be seen once again in this view along with opening 106.

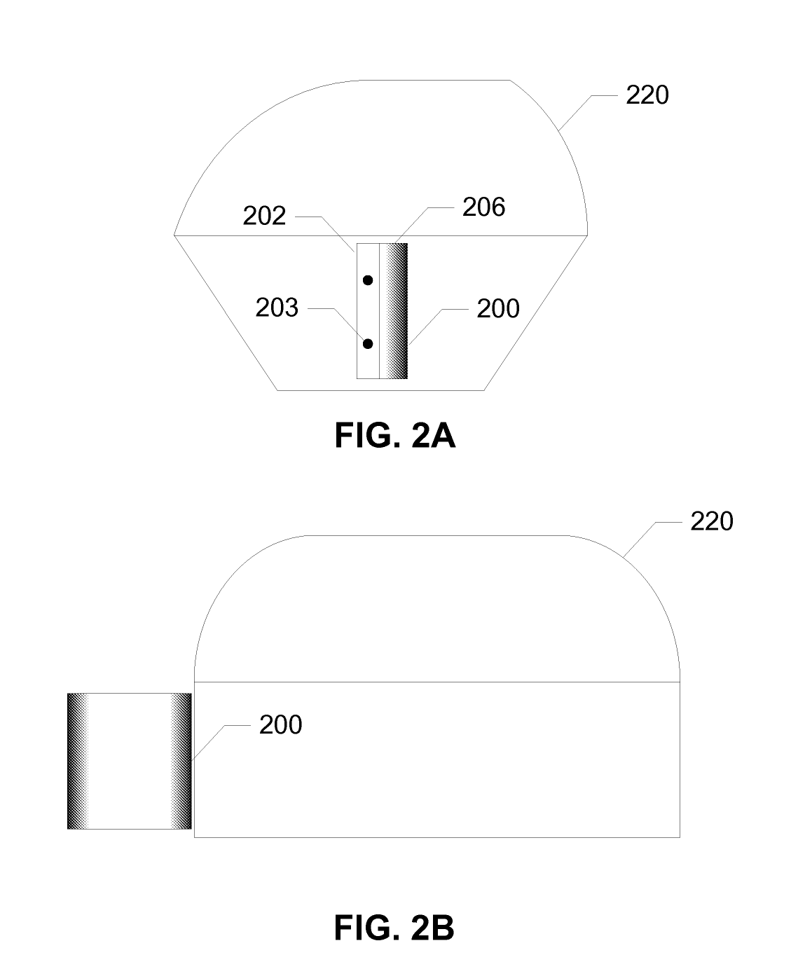

FIGS. 2A-B show a mounting bracket 200 for a drink holder attached to a trunk 220 of a motorcycle, according to an exemplary embodiment of the present invention. FIG. 2A shows trunk 220 with flange 202 attaching mounting bracket 200. Mounting bracket 200 is oriented so that opening 206 is facing upward. Flange 202 is attached using screws 203. FIG. 2B shows another view of mounting bracket 200 attached to trunk 220.

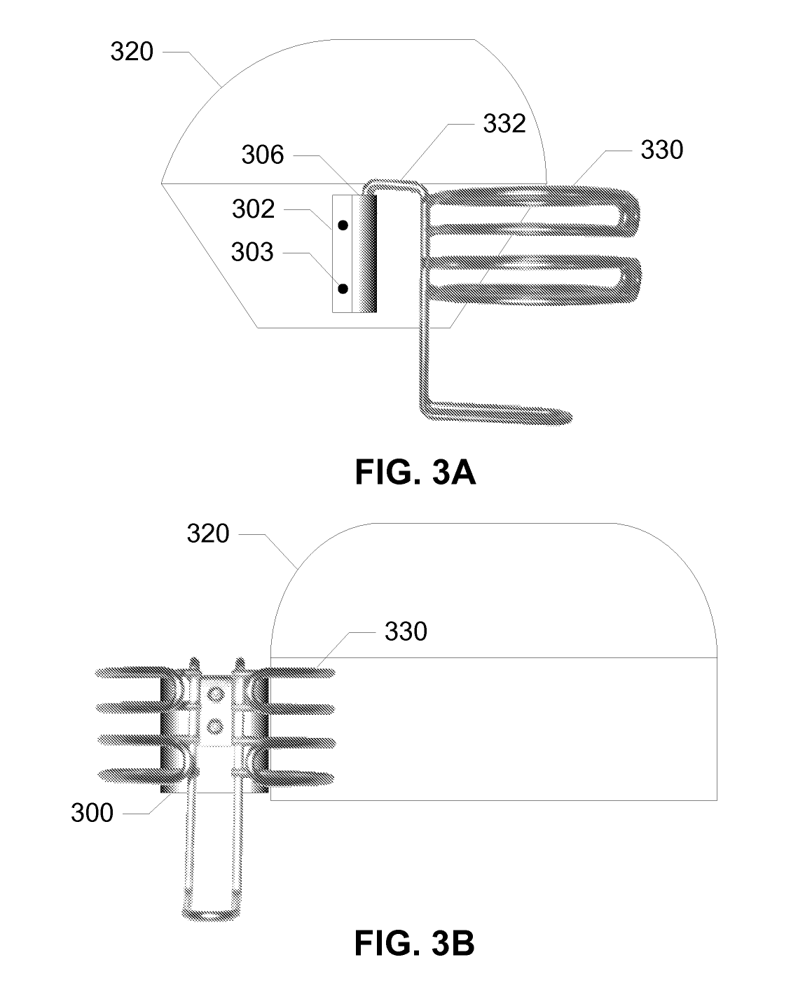

FIGS. 3A-B show a drink holder 330 attached to a trunk 320 of a motorcycle, according to an exemplary embodiment of the present invention. In this exemplary embodiment, trunk 320 is placed towards the rear of a motorcycle, just behind where a passenger sits. Mounting bracket 300 is secured to trunk 320 at flange 302 using screws 303. In other embodiments, fasteners, such as screws, bolts, nails, rivets, epoxy, strong adhesives, etc., fixedly secure mounting bracket 300 to trunk 320 through small apertures in flange 302. An opening 306 at the top of mounting bracket 300 creates an entrance to a cavity. Drink holder 330 includes a mounting insert 332 which is insertable into the cavity of mounting bracket 300 through opening 306. FIG. 3B shows a second view of drink holder 330 attached to trunk 320 of a motorcycle.

The mounting bracket is attached to the trunk preferably oriented so that the opening is at the top of the mounting bracket. This orientation maximizes the use of gravity to hold the attachment member inside the cavity of the mounting bracket. However, other orientations are possible and many make use of gravity to hold the attachment member in place. Orientations where the opening is at the sides or bottom of the mounting bracket may require a locking mechanism. A locking mechanism can be a latch, a lever, or anything else that will secure the attachment member inside the cavity of the mounting bracket. The locking mechanism can be active, such as using a spring, so that it automatically locks upon insertion into the mounting bracket, or passive, so that it requires user action before locking the attachment member inside the cavity of the mounting bracket. When using another orientation, the attachment member is shaped so that the portion insertable into the cavity of the mounting bracket is angled. The optimal angle is such that when the attachment member is inserted into the cavity of the mounting bracket a drink inside the drink holder is held upright. In this orientation of the drink, the chances of spills are minimized.

There are many embodiments of the drink holder. The drink holder includes a substantially cylindrical hollow body that is closed at one end. The cylinder walls can be solid, contain holes, or be in the form of a mere wire outline such as in FIGS. 3A-B. The cylinder walls substantially surround the circumference of the drink and hold it upright. The closed end of the cylinder holds the bottom of the drink to keep it from falling through the cylinder walls. The drink holder can be made from a larger variety of materials than the clamping and mounting brackets. The drink holder is not under as much stress as the clamping and mounting brackets.

Metals such as steel, copper, brass, etc. can be used to make the mounting bracket and drink holder as well as durable plastics and ceramics. Other suitable metals and materials will be readily recognizable to one skilled in the art. Embodiments of the mounting bracket and drink holder may include a chrome finish for aesthetics. A trunk is typically made from a wood product such as particle board. Trunks may include other materials, but in most cases will be suitable for fastening articles with bolts, screws, nails, etc. Epoxies and other strong adhesives may be suitable if other fasteners are not an option.

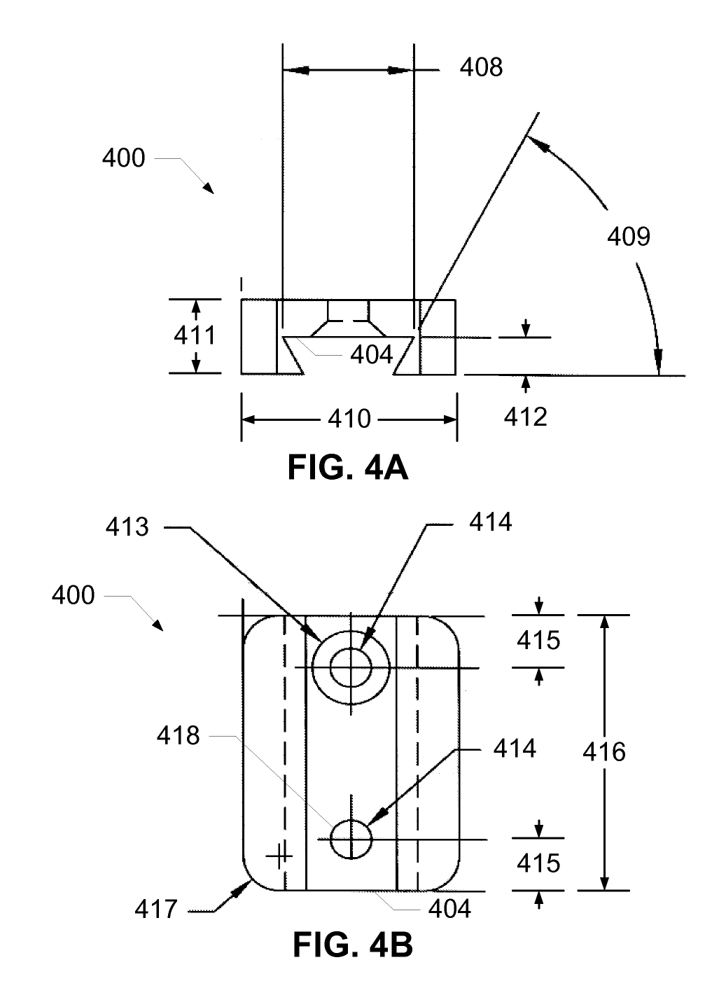

FIGS. 4A-B show a mounting bracket 400 for attaching a drink holder to a trunk of a motorcycle according to an exemplary embodiment of the present invention. FIG. 4A shows mounting bracket 400 including an opening 406, an opening width 408, a cavity wall angle 409, a mounting bracket width 410, a mounting bracket thickness 411, and a cavity thickness 412. In this exemplary embodiment, opening width 408 is 0.9137 in., cavity wall angle 409 is 60 degrees, and cavity thickness 412 is 0.25 in. Mounting bracket width 410 is 1.5 in., and mounting bracket thickness is 0.5 in. FIG. 4B shows mounting bracket 400 including a cavity 404, a protruding screw 418, a screw head diameter 413, a screw diameter 414, a screw distance 415, a mounting bracket height 416, and a radius of curvature 417. In this exemplary embodiment, screw head diameter 413 is 0.5312 in., screw diameter 414 is 0.2812 in., and screw distance 415 is 0.375 in. Mounting bracket height 416 is 2 in., and radius of curvature 417 is 0.25 in. In this embodiment, cavity 404 is screwed into a trunk housing two screws. Mounting bracket is cut so that one of the screws is flush with the inside of cavity 404 while protruding screw 418 protrudes into the cavity. This is placed so that a mounting insert will stop when it hits protruding screw 418. Many other dimensions are possible and are adjusted for drink size, weight, material strength, etc. Other configurations will become readily recognizable to those having skill in the art upon reading this disclosure.

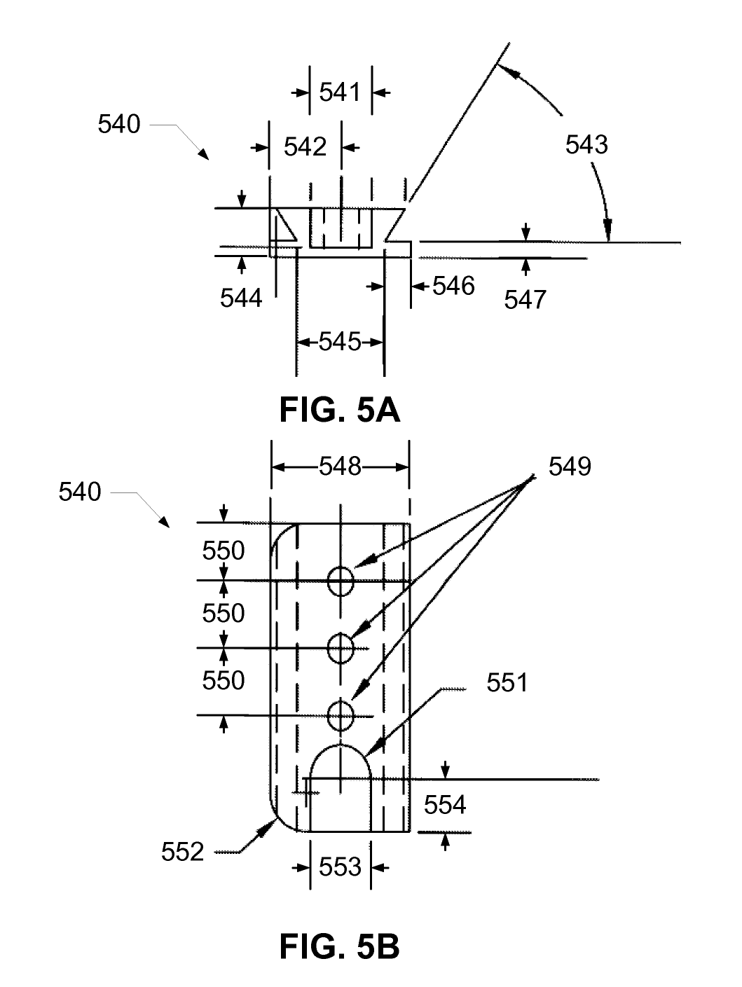

FIGS. 5A-B show a mounting insert for attaching a drink holder to a trunk of a motorcycle, according to an exemplary embodiment of the present invention. FIG. 5A shows mounting insert 540 including an attachment opening width 541, a mounting insert distance 542, a mounting insert angle 543, a mounting insert thickness 544, a mounting insert inner width 545, a mounting insert tab width 546, and a mounting insert tab thickness 547. In this exemplary embodiment, opening width 541 is 0.5 in., mounting insert distance 542 is 0.5 in., mounting insert angle 543 is 60 degrees to match cavity wall angle 409 of FIG. 4, mounting insert thickness 544 is 0.375 in., and mounting insert inner width 545 is 0.625 in. Mounting insert tab width 546 is 0.1875 in., and mounting insert tab thickness 547 is 0.125 in. FIG. 5B shows another view of mounting insert 540 including a mounting insert stop 551, a mounting insert width 548, three mounting insert screws 549, a mounting insert screw distance 550, a radius of curvature 552, a mounting insert stop width 553, and a mounting insert stop length 554. Mounting insert is inserted into mounting bracket 400 of FIG. 4 until mounting insert stop 551 contacts protruding screw 418. Mounting insert screws 549 are attachable to a drink holder, a mounting adjuster, etc. In this exemplary embodiment, mounting insert screws 549 have a diameter of 5/16 in., and mounting insert screw distance 550 is 0.4375 in. Mounting insert width 548 is 1 in., and radius of curvature 552 is 0.25 in. Mounting insert stop 551 has a diameter of 0.4375 in., mounting insert stop width 553 is 0.4375 in., and mounting insert stop length 554 is 0.3437 in. Many other dimensions are possible and are adjusted for drink size, weight, material strength, etc. Other configurations will become readily recognizable to those having skill in the art upon reading this disclosure.

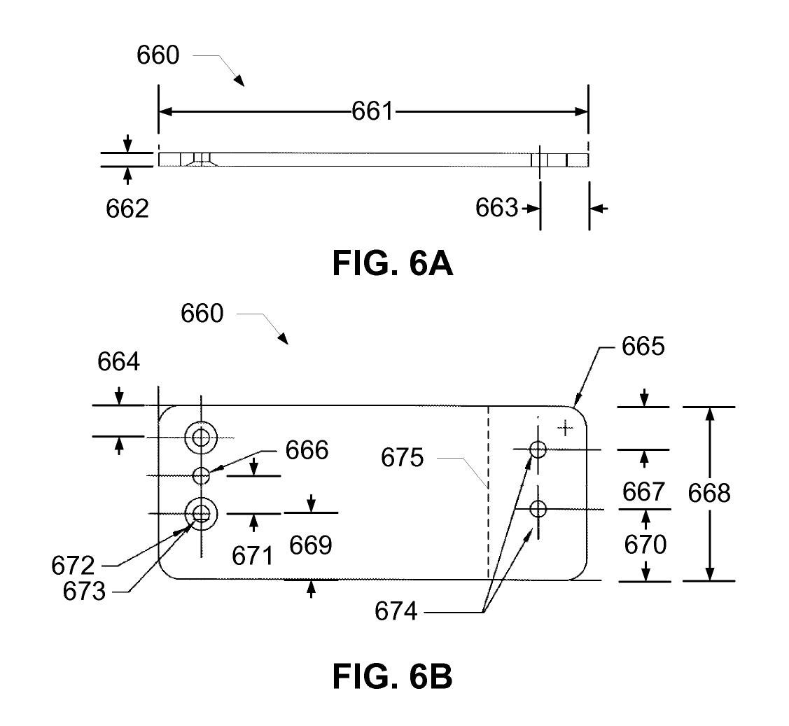

FIGS. 6A-B show a mounting adjuster 660 for attaching a drink holder to a trunk of a motorcycle, according to an exemplary embodiment of the present invention. FIG. 6A shows mounting adjuster 660 including a mounting adjuster length 661, a mounting adjuster thickness 662, and a mounting adjuster screw distance 663. In this embodiment, mounting adjuster length 661 is 5 in., mounting adjuster thickness 662 is 0.75 in., and mounting adjuster screw distance 663 is 0.5625 in. FIG. 2B shows another view of mounting adjuster 660 including mounting screws 666 and 673, drink holder screws 674, a first mounting screw distance 664, a second mounting screw distance 671, a third mounting screw distance 669, a mounting screw head diameter 672, a first drink holder screw distance 667, a second drink holder screw distance 670, a fold line 675, a mounting adjuster width 668, and a radius of curvature 665. Mounting screws 666 and 673 attach to a mounting insert, such as mounting insert 540 in FIG. 5. Drink holder screws 674 attach to a drink holder such as drink holder 330 in FIG. 3. Mounting adjuster 660 can be manipulated in various ways to suit placement needs. For example, mounting adjuster can be folded along fold line 675 to a suitable angle for attached a drink holder. Other manipulations of mounting adjuster 660 will become apparent to those having skill in the art upon reading this disclosure. In this exemplary embodiment, first mounting screw distance 664 is 0.375 in., second mounting screw distance 671 is 0.4375 in., third mounting screw distance 669 is 0.75 in., and mounting screw head diameter 672 is 0.375 in. First drink holder screw distance 667 is 0.684 in., and second drink holder screw distance 670 is 0.816 in. Mounting adjuster width 668 is 2 in., and a radius of curvature 665 is 0.25 in. Many other dimensions are possible and are adjusted for drink size, weight, material strength, etc. Other configurations will become readily recognizable to those having skill in the art upon reading this disclosure.

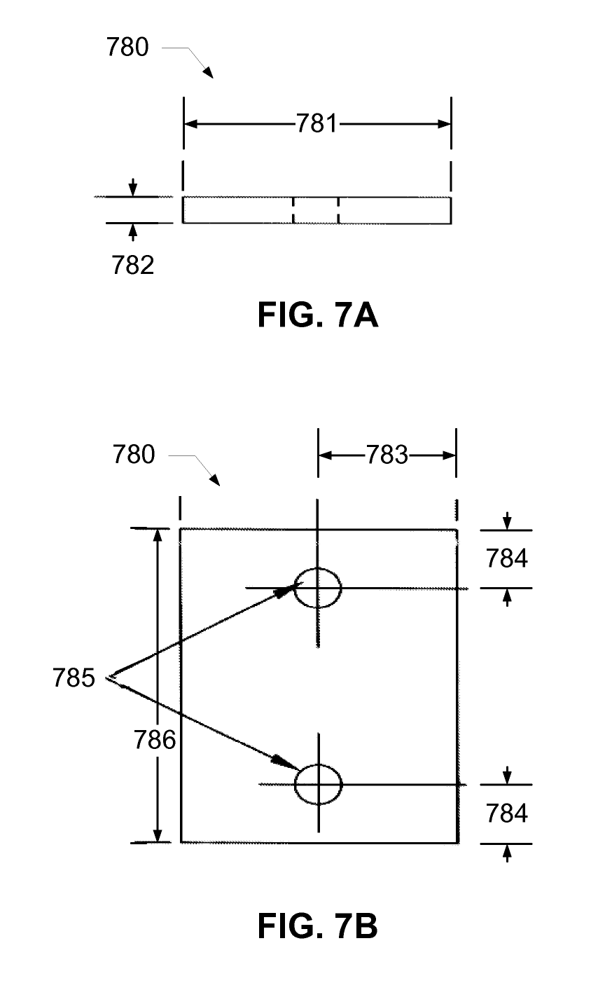

FIGS. 7A-B show a securing member 780 for attaching a drink holder to a trunk of a motorcycle, according to an exemplary embodiment of the present invention. FIG. 7A shows securing member 780 including a securing member width 781 and a securing member thickness 782. In this exemplary embodiment, securing member width 781 is 1.5 in., and securing member thickness 782 is 0.25 in. FIG. 7B shows another view of securing member 780 including fastener receivers 785, a first fastener distance 783, a second fastener distance 784, and a securing member length 786. Securing member 780 is used to reinforce the inside of a speaker housing with a mounting bracket. Fastener receivers 785 accept fasteners such as screws 203 of FIG. 2, protruding screw 418 of FIG. 4, etc. In this exemplary embodiment, first fastener distance 783 is 0.75 in., second fastener distance 784 is 0.375 in., and securing member length 786 is 2 in. Many other dimensions are possible and are adjusted for drink size, weight, material strength, etc. Other configurations will become readily recognizable to those having skill in the art upon reading this disclosure.

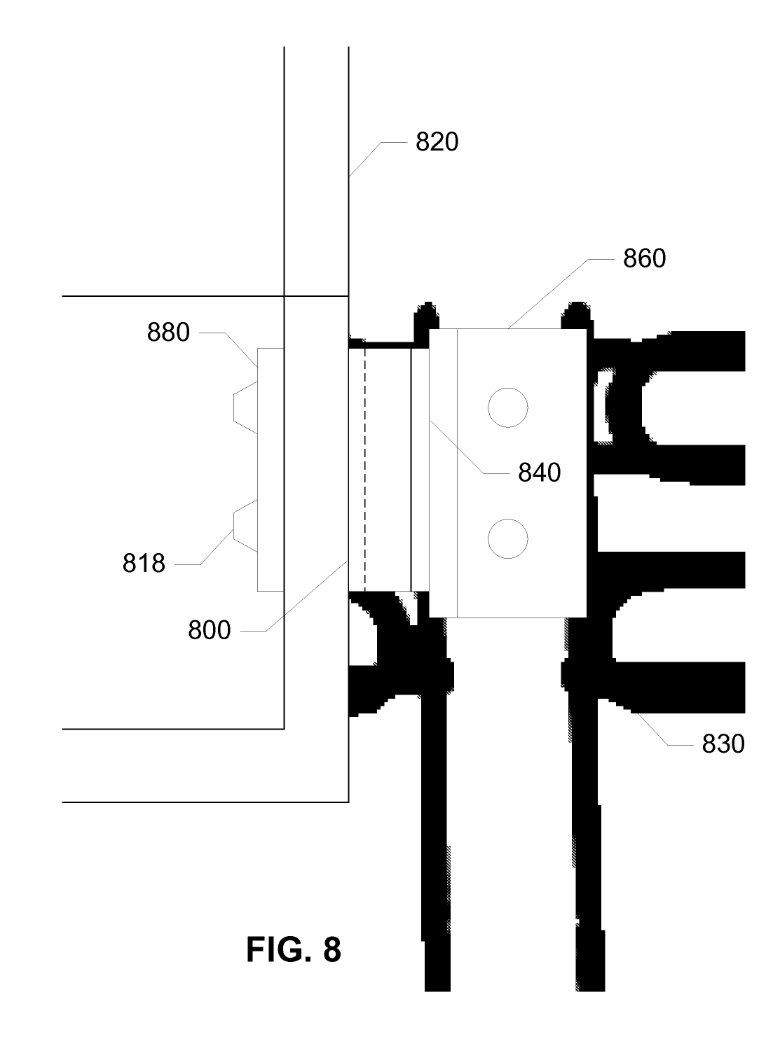

FIG. 8 shows an assembly for attaching a drink holder to a trunk of a motorcycle, according to an exemplary embodiment of the present invention. The assembly includes a mounting bracket 800, a mounting insert 840, a mounting adjuster 860, and a securing member 880. The assembly attaches a drink holder 830 to a speaker housing 820. Mounting bracket 800 attaches to speaker housing 820 with fasteners such as screws 818. Screws 818 go through securing member 880, which is on the inside of speaker housing 820, to support speaker housing 820. Mounting insert 840 is inserted into mounting bracket 800 such that gravity and friction holds them in a fixed position. Mounting adjuster 860 is fixedly attached to mounting insert 840. Mounting adjuster 860 has been bent such that drink holder 830 is oriented forward. Mounting adjuster 860 is capable of many other modifications and manipulations which will become apparent to those having skill in the art upon reading this disclosure.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A drink holding assembly for a motorcycle comprising:
a drink holder having a mounting insert; and
a mounting bracket having a flange attached to a trunk and a cavity fixedly containing the mounting insert;
wherein the mounting bracket fixes the drink holder so that a drink is held upward.

2. The assembly in claim 1, wherein the drink holder is made from one of steel, copper, brass, titanium, plastics, ceramics, and carbon fiber.

3. The assembly in claim 1, wherein the drink holder comprises a wire frame.

4. The assembly in claim 1, wherein the mounting bracket is made from one of steel, copper, brass, titanium, durable plastics, ceramics, and carbon fiber.

5. The assembly in claim 1, wherein the mounting bracket attachment to the mounting insert is a releasable attachment.

6. The assembly in claim 5, wherein the releasable attachment includes a locking mechanism.

7. A drink holding assembly for a motorcycle comprising:
a hollow cylindrical member having a closed end, an open end, and an outer wall; and
a mounting bracket attached to a trunk and a cavity fixedly containing a mounting insert;
wherein the mounting bracket fixes the hollow cylindrical member so that a drink is held upward.

8. The assembly in claim 7, wherein the hollow cylindrical member is made from one of steel, copper, brass, titanium, plastics, ceramics, and carbon fiber.

9. The assembly in claim 7, wherein the hollow cylindrical member comprises a wire frame.

10. The assembly in claim 7, wherein the mounting bracket is made from one of steel, copper, brass, titanium, durable plastics, ceramics, and carbon fiber.

11. The assembly in claim 7, wherein the mounting bracket attachment to the mounting insert is a releasable attachment.

12. The assembly in claim 11, wherein the releasable attachment includes a locking mechanism.

13. A method of holding a drink on a motorcycle comprising:
attaching a mounting bracket to a trunk of a motorcycle; and
fixing a drink holder to the mounting bracket;
wherein the mounting bracket fixes the drink holder so that a drink may be held substantially upright when inserted into the drink holder.

14. The method in claim 13, wherein the attaching comprises releasably attaching a mounting insert to the mounting bracket.

15. The method in claim 13, further comprising bending a portion of a mounting adjuster to correct the orientation of the drink.
